(19) United States
(12) Patent Application Publication
(10) Pub. No.: US 2013/0009343 A1
(43) Pub. Date: Jan. 10, 2013

(54) METHOD AND APPARATUS FOR SIMULTANEOUSLY PRODUCING A PLURALITY OF BILLETS OF A FORMABLE MATERIAL

(75) Inventor: Marat Zangavar, Moscow (RU)

(73) Assignee: NCT GMBH, Garbsen (DE)

(21) Appl. No.: 13/540,835

(22) Filed: Jul. 3, 2012

(30) Foreign Application Priority Data
Jul. 4, 2011 (DE) 10 2011 106 374.2

(51) Int. Cl. B29C 35/00

(52) U.S. Cl. 264/320; 425/384

(57) ABSTRACT

A method and an apparatus simultaneously produces a plurality of billets of a formable material with a press, which includes a plate-like female die, provided with nozzles in the form of continuous holes, and also a rotating hub provided with radially disposed rollers that are pressed onto the female die. The method provides that the female die is heated to a temperature above the boiling temperature of the moisture contained in the formable material, and in this way the material pressed through the hole-like nozzles of the female die is dried. The apparatus includes the female die having two plates resting closely and tightly against one another, and in at least one of the plates, a conduit for a heating medium or coolant is made in the surface facing toward the other plate.

This application claims priority to German Patent Application DE102011106374.2 filed Jul. 4, 2011, the entirety of which is incorporated by reference herein.

### FIELD OF THE INVENTION

The present invention relates to a method and an apparatus for simultaneously producing a plurality of billets of a formable material with a press, which includes a plate-like female die, provided with nozzles in the form of continuous holes, and also includes a rotating hub provided with radially disposed rollers that are pressed onto the female die.

Such presses are already being used for granulating certain materials, such as for granulating wood waste, plastics, and feed media.

In known machines of this type, the product to be granulated has to be dried and freed of foreign bodies in an upstream system. This represents an additional expense in terms of machinery, space, and labor.

### SUMMARY OF THE INVENTION

The invention proposes a simple method and a simple apparatus such that an upstream system for drying the product to be granulated can be dispensed with. It is a further object that a system for freeing the formable material from foreign bodies can also be dispensed with.

The invention includes heating the female die to a temperature of the boiling point of the moisture contained in the deformable material, and in this way, drying the material pressed through the hole-like nozzles in the female die.

The drying procedure is carried out according to the invention in a press for simultaneously producing a plurality of billets of a formable material. This press comprises a plate-like female die, which is penetrated by hole-like nozzles, and a rotating hub, provided with radially disposed rollers which are pressed on the female die.

The female die includes two plates resting closely and tightly against one another, of which in at least one plate, a conduit is made, in the surface facing toward the other plate, for a heating medium or coolant, with which the female die is heated to such a high temperature that the now-gaseous moisture escapes into the environment through the holes in the female die and the conduits located downstream of the holes.

Since with the escaping moisture the billet of material becomes looser or less compact, it is expedient if the material pressed through the nozzles in the female die is compacted along its way through the nozzles.

This can be attained by providing that the hole-like nozzles in the bottom plate of the female die, on their side facing toward the rollers, have a cylindrical portion, which continues in a conically tapering portion.

Expediently, before it emerges from the nozzle in the female die, the material is freed of the gaseous moisture it contains.

Advantageously, the hole-like nozzles in the bottom plate of the female die, on their side facing away from the rollers, have a conical end portion.

In such a way, it is successfully possible to dispense with a drying system upstream of the press (of the kind required in previously known older embodiments) and thereby economize in terms of machinery, space, and labor.

The invention further provides that if foreign bodies turn up on the female die, or if some of the nozzles become clogged with foreign bodies, the drive of the press shuts off automatically. This is done by providing that the rotating hub provided with radially disposed rollers is supported displaceably on its drive shaft, and that a switch serving to shut off the rotary motion of the hub is disposed in the displacement path of the hub.

Thus in the event of a problem, the switch can be automatically actuated, and after that, the requisite cleaning can be done. This occurs only occasionally and represents only a minimal expense, in comparison to a general pretreatment of all the material to free it of foreign bodies.

### BRIEF DESCRIPTION OF THE DRAWINGS

The invention will be described in further detail below in terms of an exemplary embodiment shown in the drawings. In the drawings:

FIG. 1 is a sectional view of a press according to the invention;

FIG. 2 is a top view of a female die, provided with nozzles, together with a rotating hub and rollers;

FIG. 3 is an enlarged sectional view of a part of a female die with nozzles;

FIG. 4 is an enlarged sectional view of a nozzle in the female die; and

FIG. 5 shows the location of the heating conduits in the female die.

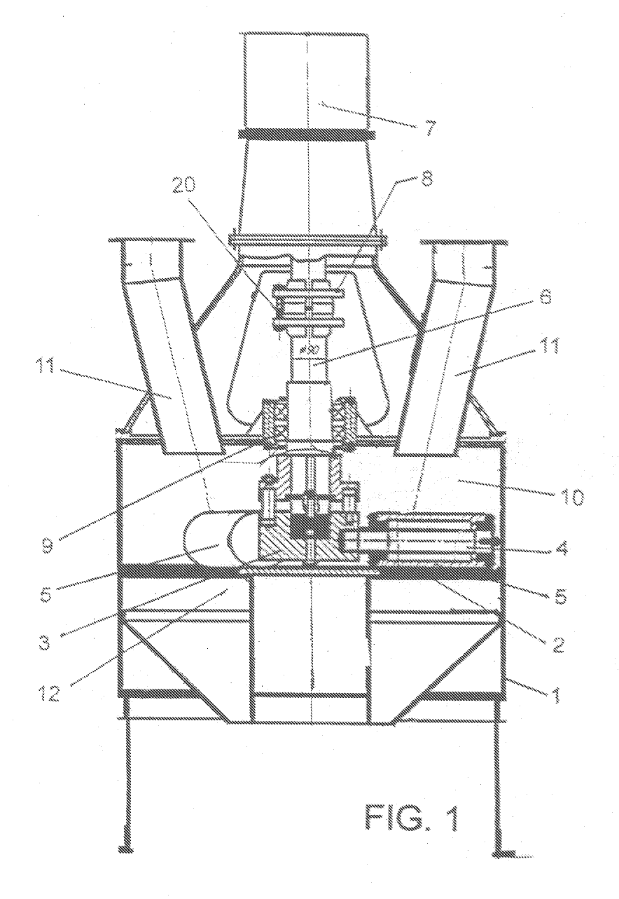

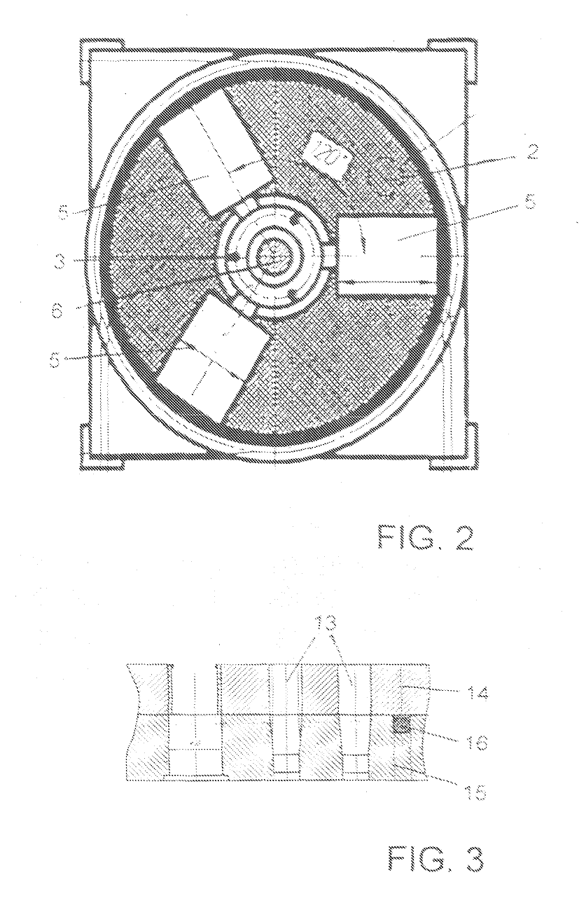

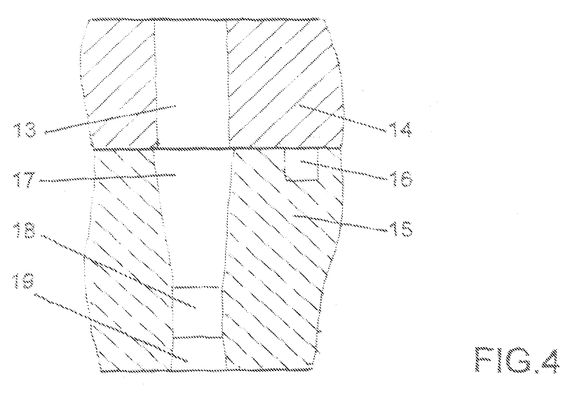

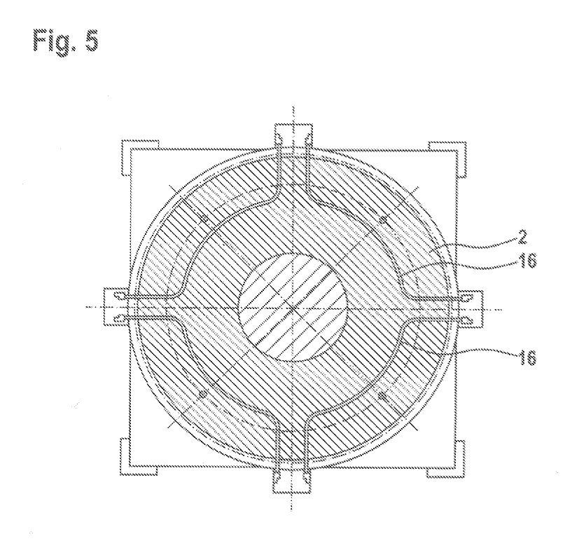

### DETAILED DESCRIPTION

The press in this exemplary embodiment includes a machine housing 1, in which a female die 2 is fixedly built in, approximately in the middle. Above the female die is a rotating hub 3, which has one roller 5 on each of three radially disposed arms 4. Each roller 5 rolls on the surface of the female die 2. A drive shaft 6 for the rotating hub 3 is driven by a motor 7. The drive shaft 6 is split in its course, and a connector 8 ensures its displaceability, in a manner fixed against relative rotation, in the longitudinal direction of the two parts of the shaft under spring pressure or pneumatic pressure. The lower part of the shaft is supported in a bearing 9, and the upper part of the shaft is supported in the motor 7.

The female die 2 divides the machine housing 1 into one chamber 10 above the female die 2, into which chamber the product to be processed is poured via charging tubes 11, and one chamber 12 below the female die 2, into which chamber the billets, shaped in nozzles 13 of the female die 2, drop, once they have been formed in the nozzles 13.

The female die 2 comprises two plates 14, 15, set tightly one upon the other, which on the sides facing toward one another have conduits 16 for receiving heating elements.

The nozzles 13 in the plates 14, 15 of the female die 2 are shaped in a special way. In the plate 14 on which the rollers 5 roll, the nozzles 13 have a cylindrical shape. The nozzles 13 in the plate 15 are aligned with them, and adjacent to the plate 14 they first have a slightly tapering (or contracting) conical portion 17, adjoining it a cylindrical portion 18, and on the end again a slightly widening (or expanding) conical end portion 19.

The basic purpose of this shape or embodiment is that the composition rolled into the nozzles 13 of the plate 14 of the female die 2 is first dried by the high temperature of the female die 2. The dried composition shrinks as a result of the loss of moisture and is therefore compacted through the contracting conical portion 17 in the plate 15, so as then to be dried and shaped in the cylindrical portion 18. In the expanding conical end portion 19, the dry billet leaves the nozzle 13 in the plate 15. Thus an otherwise usual pre-drying operation can be dispensed with.

In the otherwise usual pre-drying or pretreatment operation, unwanted objects, above all, of metal, are simultaneously removed prior to the transfer to the press, so that they do not hinder the operation of the press. According to the invention, detection and removal of unwanted objects can also be done in some other way in the press itself.

Foreign bodies that have entered the press through the charging tubes 11 cause clogs upstream of and inside the nozzles 13. These accumulations of foreign bodies upstream of and inside the nozzles 13 have the effect that the rollers 5 of the rotating hub 3 no longer roll directly on the female die 2 but instead at a higher level. In the process, they have pushed the rotating hub 3 away from the female die 2, shortening or displacing its drive shaft 6. A switch 20 controlled by the axial location of the rotating hub 3 switches off the drive current if the rotating hub 3 has moved too far away from the female die 2 because of the accumulation of foreign bodies that do not fit through the holes 13 in the female die 2.

A particular advantage of the invention resides in the simultaneous removal of the moisture from the formable composition processed in the press and the compacting of the material in the individual nozzles 13. As a result of the heating of the formable composition in the nozzles 13 of the hot female die 2, the moisture contained in the formable composition is converted to the vapor or gaseous state and thus can escape freely from the nozzles 13 into the environment, as a result of which the billet passing through the nozzles 13 initially becomes looser but then is compacted again in the contracting conical portions 17 of the nozzles 13, because the material, dried beforehand in the manner described, is united in the conical portions 17 of the nozzles 13 over a smaller cross section and is thus compacted.

Experiments in billet formation and granulation of sawdust have proved successful upon heating of the female die to 120° C. to 180° C. at press pressures of 100 Mpa to 50 Mpa.

### LIST OF REFERENCE NUMERALS

1 Machine housing
2 Female die
3 Rotating hub
4 Arm
5 Roller
6 Drive shaft
7 Motor
8 Connector
9 Bearing
10 Chamber above the female die
11 Charging tube
12 Chamber below the female die
13 Nozzle in the female die
14 Plate
15 Plate
16 Conduit for heating element
17 Conical portion
18 Cylindrical portion
19 Conical end portion
20 Switch

1. A method for simultaneously producing a plurality of billets of a formable material, comprising:
providing a press, which includes a plate-like female die having a plurality of nozzles formed as continuous holes and also including a rotating hub having with radially disposed rollers pressed onto the female die;
heating the female die to a temperature above a boiling temperature of a moisture contained in the formable material, to dry the formable material pressed through the nozzles of the female die.

2. The method according to claim 1, and further comprising dehumidifying and compacting the formable material by passing the formable material through conical path portions of the nozzles, the conical path portions having decreasing cross-sectional areas.

3. The method according to claim 1, and further comprising freeing the formable material of gaseous moisture contained in the formable material, before the formable material emerges from the nozzles in the female die.

4. The method according to claim 3, wherein clogging of the nozzles by foreign bodies and a resultant backup of material developing on the female die causes the rotating hub to lift away from the female die and actuate a switch to shut off operation of the press.

5. The method according to claim 1, wherein clogging of the nozzles by foreign bodies and a resultant backup of material developing on the female die causes the rotating hub to lift away from the female die and actuate a switch to shut off operation of the press.

6. The method according to claim 2, wherein clogging of the nozzles by foreign bodies and a resultant backup of material developing on the female die causes the rotating hub to lift away from the female die and actuate a switch to shut off operation of the press.

7. An apparatus for simultaneously producing a plurality of billets of a formable material, comprising:
a press including a plate-like female die having nozzles formed as continuous holes and also including a rotating hub having radially disposed rollers pressed onto the female die;
the female die including two plates resting closely and tightly against one another, with at least one of the plates including a conduit for a heating medium or a coolant made in a surface facing toward the other plate.

8. The apparatus according to claim 7, wherein the nozzles in the bottom plate of the female die, each have a contracting conical portion on a side facing toward the rollers, which continues in a cylindrical portion in a direction away from the rollers.

9. The apparatus according to claim 8, wherein the nozzles in the bottom plate of the female die each have an expanding conical end portion on a side facing away from the rollers.

10. The apparatus according to claim 9, and further comprising a drive shaft for axially displaceably supporting the rotating hub; and a switch for shutting off rotary motion of the rotating hub upon axial displacement of the rotating hub.

11. The apparatus according to claim 7, wherein the nozzles in the bottom plate of the female die each have an expanding conical end portion on a side facing away from the rollers.

12. The apparatus according to claim 11, and further comprising a drive shaft for axially displaceably supporting the rotating hub; and a switch for shutting off rotary motion of the rotating hub upon axial displacement of the rotating hub.

13. The apparatus according to claim 7, and further comprising a drive shaft for axially displaceably supporting the rotating hub; and a switch for shutting off rotary motion of the rotating hub upon axial displacement of the rotating hub.

14. The apparatus according to claim 8, and further comprising a drive shaft for axially displaceably supporting the rotating hub; and a switch for shutting off rotary motion of the rotating hub upon axial displacement of the rotating hub.
